(19) United States
(12) Patent Application Publication
(10) Pub. No.: US 2018/0147714 A1
(43) Pub. Date: May 31, 2018

(54) MULTI-JOINT TOOLS WITH CYLINDRICAL SEGMENTS

(71) Applicant: General Electric Company, Schenectady, NY (US)

(72) Inventors: Steven Lynn HUSKINS, Greenville, SC (US); Todd DANKO, Niskayuna, NY (US)

(21) Appl. No.: 15/362,308

(22) Filed: Nov. 28, 2016

(51) Int. Cl. B25G 1/02; F01D 5/18; F01D 9/02; B25G 1/06

(52) U.S. Cl. CPC B25G 1/02; F01D 5/18; F05D 2220/32; B25G 1/06; F01D 9/02

(57) ABSTRACT

This application provides tools for use with gas turbine engines. Example tools may include multi joint tools for use in a complex environment that has accessibility constraints, such as with a gas turbine engine. The multi joint tools may include a number of pie cut cylinders connected in series. The number of pie cut cylinders may include a connecting member and a receiving portion, where the number of pie cut cylinders is connected by a first connecting member of a first pie cut cylinder engaged with a first receiving portion of a second pie cut cylinder. The multi joint tools may include an end cut cylinder forming a first end of the multi-joint tool. The end cut cylinder may include a second connecting member engaged with a second receiving portion of the first pie cut cylinder.

### TECHNICAL FIELD

The present application and the resultant patent relate generally to tools, and more particularly relate to multi joint tools with cylindrical segments that can be used in complex environments, such as gas turbine engines.

### BACKGROUND

Gas turbine engines and related components may include many bends, curves, joints, and other features. For example, fluids, such as air or fuel, may be directed through one or more portions of a gas turbine engine along a serpentine or other non-linear path. Components with such non-linear configurations may include joints, connections, screws, bolts, nuts, seals, fittings, or other features that may be difficult to access. For example, accessing a bolt that is positioned behind a U-shaped joint may be difficult with statically configured tools, such as a wrench. In another example, a screw or bolt may be positioned at a difficult to reach angle. Accordingly, flexible tools and/or tools with modifiable configurations may be desired.

### SUMMARY

This application and the resultant patent provide a multi joint tool. The multi joint tool may include a number of pie cut cylinders connected in series. The number of pie cut cylinders may include a connecting member and a receiving portion, where the number of pie cut cylinders is connected by a first connecting member of a first pie cut cylinder engaged with a first receiving portion of a second pie cut cylinder. The multi-joint tool may include an end cut cylinder forming a first end of the multi-joint tool. The end cut cylinder may include a second connecting member engaged with a second receiving portion of the first pie cut cylinder.

This application and the resultant patent further provide a method of using a multi joint tool in a complex environment that has accessibility constraints, such as a gas turbine engine. The method may include the steps of providing a first pie cut cylindrical segment, attaching a second pie cut cylindrical segment to the first pie cut cylindrical segment, attaching an end cut cylindrical segment to the second pie cut cylindrical segment, rotating the first pie cut cylindrical segment with respect to the second pie cut cylindrical segment, and guiding the multi-joint tool through a u-joint of the gas turbine engine.

This application and the resultant patent further provide a serially connected multi joint tool for use in a complex environment that has accessibility constraints, such as with a gas turbine engine that includes a u-joint. The multi-joint tool may include a first pie cut cylindrical segment with a first angled surface and a second angled surface opposite the first angled surface, and a second pie cut cylindrical segment mechanically attached to the first pie cut cylindrical segment. The second pie cut cylindrical segment may include a third angled surface adjacent to the second angled surface of the first pie cut cylindrical segment. The first pie cut cylindrical segment may be configured to rotate with respect to the second pie cut cylindrical segment. The multi-joint tool may include an end cut cylindrical segment mechanically attached to the second pie cut cylindrical segment. The end cut cylindrical segment may include a fourth angled surface adjacent to the second pie cut cylindrical segment, and a flat surface opposite the fourth angled surface.

These and other features and improvements of this application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine.

FIG. 2 is a perspective view of an embodiment of a multi joint tool as may be described herein.

FIG. 3 is a perspective view and a cross-sectional view of an end cut cylinder, and a cross-sectional view of a pie cut cylinder as may be described herein.

FIG. 4 is a side view of different embodiments of a multi joint tool as may be described herein, as well as an example embodiment of a multi joint tool in use with gas turbine engine components.

### DETAILED DESCRIPTION

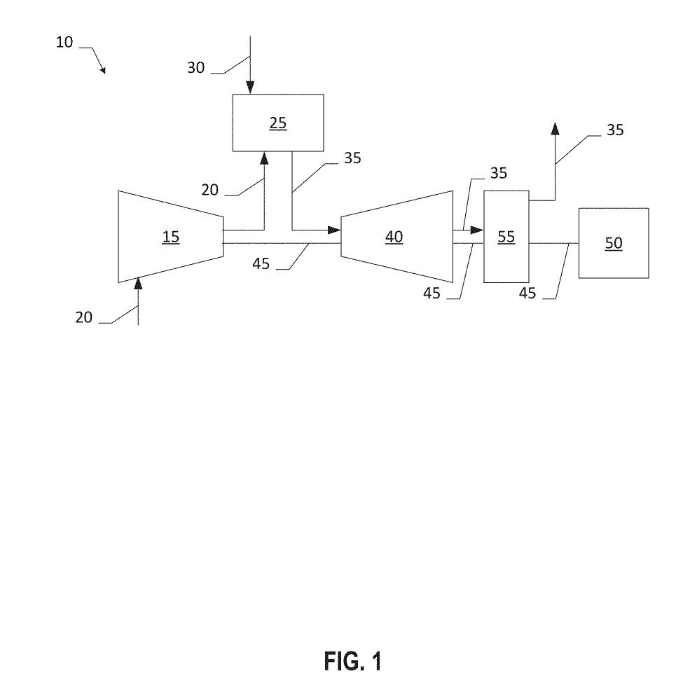

Referring now to the drawings, in which like numerals refer to like elements throughout the several views, FIG. 1 shows a schematic diagram of a gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 and an external load 50, such as an electrical generator and the like via a shaft 45. The flow of combustion gases 35 may be delivered from the turbine 40 to an exhaust frame 55 positioned downstream thereof. The exhaust frame 55 may contain and/or direct the flow of combustion gases 35 to other components of the gas turbine engine 10. For example, the exhaust frame 55 may direct the flow of combustion gases 35 to an exhaust plenum or an exhaust diffuser. Other configurations and other components may be used herein.

The gas turbine engine 10 may use natural gas, various types of syngas, and/or other types of fuels. The gas turbine engine 10 may be any one of a number of different gas turbine engines offered by General Electric Company of Schenectady, N.Y., including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

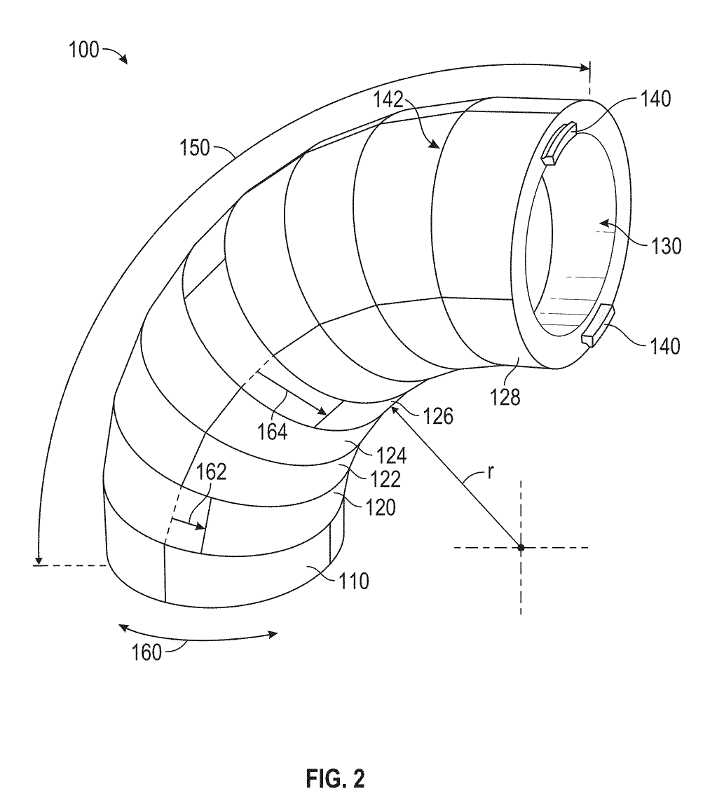

FIG. 2 illustrates an embodiment of a multi joint tool 100 as may be described herein. The multi joint tool 100 may be flexible and/or have a modifiable configuration. The multi joint tool 100 may be moveable and/or reconfigured so as to maneuver into places or at angles that may otherwise not be possible or that may not be possible with typical devices. In some embodiments, the multi joint tool 100 may be in the form of a snake with joints formed by pie cut cylinders. The multi joint tool 100 may be used with a gas turbine engine or another device or in any complex environment that has accessibility constraints.

In FIG. 2, the multi joint tool 100 may be formed of one or more cylindrical segments. For example, the multi joint tool 100 may include a first end cut cylindrical segment 110 at a first end of the multi-joint tool 100. The multi-joint tool 100 may include one or more pie cut cylinders or pie cut cylindrical segments. The one or more pie cut cylinders may be connected to each other in a serial connection, as illustrated in FIG. 2, where adjacent pie cut cylinders are mechanically attached to each other. One or more of the pie cut cylinders forming the multi joint tool 100 may be mechanically attached to the first end cut cylindrical segment 110. For example, a first pie cut cylinder 120 may be mechanically attached to the first end cut cylindrical segment 110. The mechanical attachment may be any suitable mechanical attachment that allows at least one degree of freedom movement between adjacent end cut and/or pie cut cylindrical segments. In some embodiments, mechanical attachments may allow only one degree of freedom between adjacent cylindrical segments. The respective pie cut cylinders may rotate or otherwise have one degree of freedom between adjacent pie cut cylinders. The multi joint tool 100 may include any number of pie cut cylinders connected in series.

A second pie cut cylinder 122 may be mechanically attached or coupled to the first pie cut cylinder 120. The second pie cut cylinder 122 may be configured to rotate with respect to the first pie cut cylinder 120. A third pie cut cylinder 124 may be mechanically attached or coupled to the second pie cut cylinder 122. The third pie cut cylinder 124 may be configured to rotate with respect to the second pie cut cylinder 122. A fourth pie cut cylinder 126 may be mechanically attached or coupled to the third pie cut cylinder 124. The fourth pie cut cylinder 126 may be configured to rotate with respect to the third pie cut cylinder 124. The multi-joint tool 100 may include a second end cut cylinder 128 positioned at a second end of the multi-joint tool 100.

In some embodiments, the cylinders or cylindrical segments forming the multi-joint tool 100 may each have the same inner diameter, such that a diameter of an inner space 130 formed by the cylinders of the multi joint tool 100 is consistent. In other embodiments, the cylinders may have different inner diameters. As shown in FIG. 2, the inner space 130 may be consistent from the first end of the multi joint tool 100 to the second end of the multi joint tool 100. The inner space 130 may be used to easily feed and/or guide devices or materials, such as wiring or media, through the multi joint tool 100 due to the consistent sizing of the inner space 130. The inner space 130 may be a central passage having a consistent diameter through the multi-joint tool 100.

The cylinders or cylindrical segments forming the multi-joint tool 100 may be mechanically attached or coupled to adjacent cylinders or segments. For example, cylinders may include one or more connecting members 140 configured to engage corresponding receiving portions 142 on adjacent cylinders. The connecting members 140 may be configured to allow rotation between adjacent cylinders while maintaining contact between adjacent surfaces of the respective cylinders. Other embodiments may include, for example, ball joints, or other mechanical attachments or couplings.

The multi joint tool 100 may have an adjustable length 150. For example, to shorten the multi-joint tool 100, one or more pie cut cylinders and/or end cut cylinders may be removed or disconnected from one or both ends of the multi joint tool 100. To lengthen the multi-joint tool 100, one or more pie cut cylinders and/or end cut cylinders may be added to one or both ends of the multi joint tool 100, or by changing dimensions of any one of the cylinders.

The multi joint tool 100 may be configured to form one or more bends or curves. For example, in FIG. 2, the multi joint tool 100 may form a curve with a radius r. The shape or geometry formed by the multi joint tool 100 may be modifiable and/or adjustable. For example, the radius r of the curve may be adjustable by rotating one or more of the cylinders or the cylindrical segments forming the multi-joint tool 100. In the illustrated embodiment, the first pie cut cylinder 120 may have a first rotation offset 162. The first rotation offset 162 may be a distance between a central axis of the first pie cut cylinder 120 and an adjacent cylinder, which in FIG. 2 is the first end cut cylinder 110. Similarly, the fourth pie cut cylinder 126 may have a second rotation offset 164. The respective rotation offsets may adjust or impact the overall radius r of the multi joint tool 100.

The position of each pie cut cylinder or pie cut cylindrical segment relative to an adjacent pie cut cylindrical segment can be adjusted to create bends, curves, and geometries with the multi-joint tool 100. The multi-joint tool 100 can therefore maneuver into places by modifying a configuration of the multi-joint tool 100.

In some embodiments, the multi joint tool 100 may be robotically moveable or robotically controlled. For example, certain embodiments may include a controller that is configured to control rotation of one or more of the pie cut cylinders, so as to form certain geometries, such as a U-shape, a curve with a certain angle, or another geometry. In some embodiments, the angle and phase of each cylindrical segment can be manually or electronically controlled, and can include mechanical and/or electromechanical movement.

In some embodiments, the multi joint tool 100 may include an auxiliary component such as one or more of a tool head, a camera, a robot, a light, or a spray device, or any other functional object that fits within the inner space, at the second end of the multi joint tool 100. The respective auxiliary component may be attached to an end of the multi joint tool 100 or fed through the inner space 130.

The multi joint tool 100 may therefore be used in multiple environments to access difficult to reach or difficult to access locations, as well as to carry any number of various tools, working devices, wiring, media, or other components in an adjustable form, due to the consistent inner space provided by the cylinders. The multi-joint tool 100 may be modular in length and can include one or more bends. The multi joint tool 100 can be used to access or deliver devices to difficult areas, such as through u-joints.

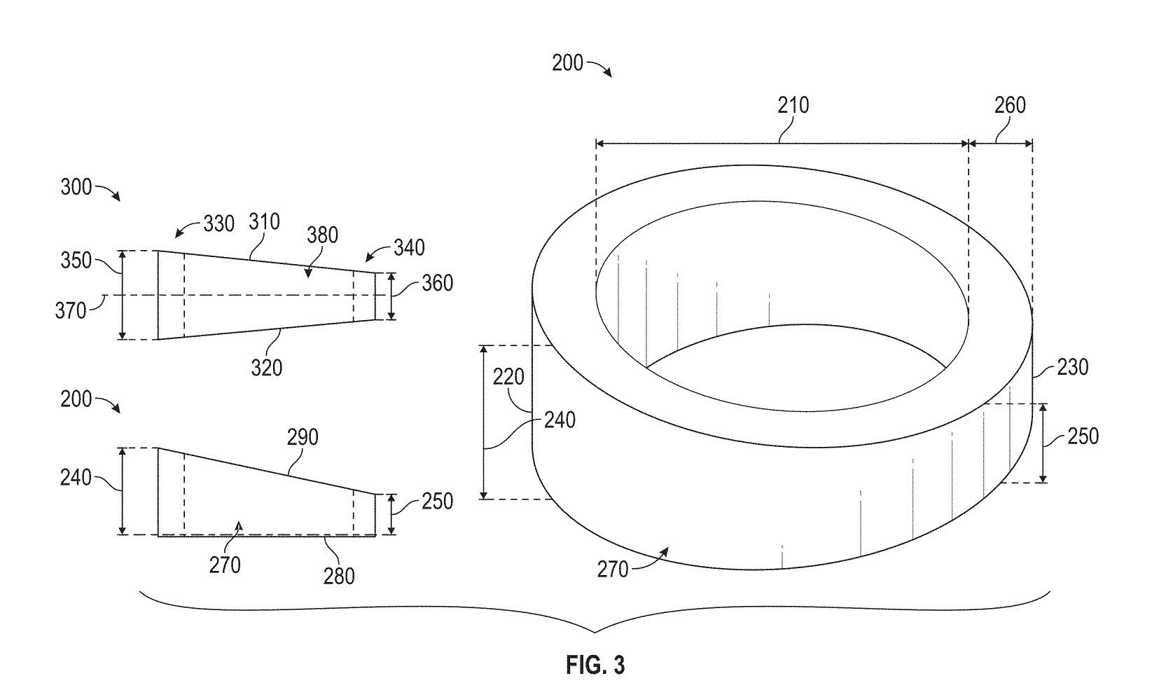

Referring to FIG. 3, an end cut cylinder 200 as may be described herein is depicted in perspective view and cross-sectional view, and a pie cut cylinder 300 as may be described herein is depicted in cross-sectional view as may be described herein. The end cut cylinder 200 may be the end cut cylinder 110 described in FIG. 2, and the pie cut cylinder 300 may be the pie cut cylinder 120 described in FIG. 2.

Multi joint tools, as described herein, may include one or more end cut cylinders, such as the illustrated end cut cylinder 200. The end cut cylinder 200 may have an inner diameter 210. At a first side 220, the end cut cylinder 200 may have a first height or a first thickness 240. At a second side 230, the end cut cylinder 200 may have a second height or a second thickness 250. The second thickness 250 may be less than the first thickness 240. The end cut cylinder 200 may include a tapered section or a tapered portion 270 between the first side 220 and the second side 230. The tapered portion 270 may be a gradual decrease in thickness of the end cut cylinder 200 from the first side 220 to the second side 230. The end cut cylinder 200 may have a wall thickness 260. In some embodiments, each cylinder forming a multi joint tool may have uniform wall thicknesses.

The end cut cylinder 200 may include one or more flat sides or flat ends 280, and one or more angled sides or angled ends 290. The flat end 280 may be perpendicular or substantially perpendicular to a side surface of the end cut cylinder 200, while the angled end 290 may form an acute angle with respect to a side surface of the end cut cylinder 200.

One or more of the cylindrical segments forming a multi-joint tool as described herein may be pie cut cylinders, such as the pie cut cylinder 300. The pie cut cylinder 300 may be cut into a slice-like shape with one or more angles or one or more angled surfaces. The pie cut cylinder 300 may include a first angled side or a first angled end 310 and a second angled side or a second angled end 320. The second angled end 320 may be opposite the first angled end 310. The angled ends 310, 320 may form angles with respect to a side surface of the pie cut cylinder 300. In some embodiments, the first angled end 310 may be angled towards the second angled end 320, and the second angled end 320 may be angled towards the first angled end 310. For example, as shown in FIG. 3, the first angled end 310 and the second angled end 320 may be angled towards each other. The first angled end 310 may have a slope that is equal to or different than a slope of the second angled end 320. The pie cut cylinder 300 may have an inner diameter equal to that of the inner diameter 210 of the end cut cylinder 200.

The pie cut cylinder 300 may include a first side 330 with a first height or a first thickness 350, and a second side 340 with a second height or a second thickness 360. The second thickness 360 may be less than the first thickness 350. The pie cut cylinder 300 may include a tapered portion 380 between the first side 330 and the second side 340 of the pie cut cylinder 300. The pie cut cylinder 300 may be symmetrical about a longitudinal axis 370.

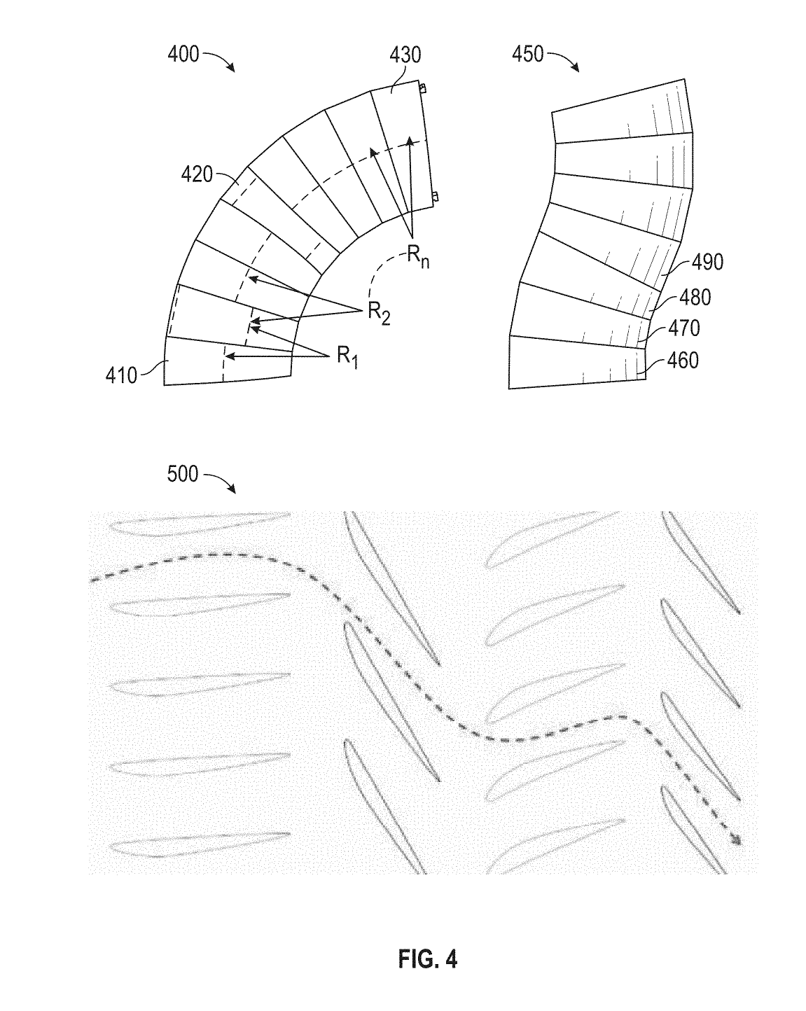

Referring to FIG. 4, a multi joint tool as may be described herein is depicted in different configurations. In FIG. 4, a multi joint tool is depicted in a curved configuration 400. The multi-joint tool may include a first end cut cylindrical segment 410, a first pie cut cylindrical segment 420, and a second pie cut cylindrical segment 430. The respective cylindrical segments may be rotated with respect to each other to form a curve of a desired radius. As illustrated in FIG. 4, certain pie cut cylindrical segments may be rotated with a first rotation amount R1, while other cylindrical segments may be rotated with a second rotation amount R2, and so forth until a desired curve is achieved with the multi joint tool. The rotation amounts may be adjusted so as to form different curved configurations.

FIG. 4 also depicts a snake configuration 450. The snake configuration may include one or more serially connected cylindrical segments that form an s-like geometry or curves in opposite directions. For example, the snake configuration 450 may include a first pie cut cylindrical segment 460, a second pie cut cylindrical segment 470 mechanically attached to the first pie cut cylindrical segment 460. The second pie cut cylindrical segment 470 may include an angled surface that is adjacent to and in contact with an angled surface of the first pie cut cylindrical segment 460. A third pie cut cylindrical segment 480 may be attached to the second pie cut cylindrical segment 470. The first, second, and third pie cut cylindrical segments 460, 470, 480 may be configured to form a curve in a first direction. A fourth pie cut cylindrical segment 490 may be coupled to the third pie cut cylindrical segment 480. The fourth pie cut cylindrical segment 490 may be rotated in an opposite direction or may otherwise be configured to form a curve in a second direction that is different than or opposite the first direction, thereby partially forming an s-like or snake geometry. Some or all of the pie cut cylindrical segments may be identical or may have some or all of the same dimensions. By rotating the respective pie cut cylindrical segments, different geometries may be formed by multi-joint tools.

FIG. 4 further illustrates an example embodiment 500 of a multi joint tool as described herein, such as the snake configuration 450, in use with a gas turbine engine. As can be seen in FIG. 4, the multi joint tool may be snaked through one or more airfoils and/or blades in order to access tough to reach areas.

A method of using a multi joint tool with a gas turbine engine may include providing a first pie cut cylindrical segment, attaching a second pie cut cylindrical segment to the first pie cut cylindrical segment, attaching an end cut cylindrical segment to the second pie cut cylindrical segment, rotating the first pie cut cylindrical segment with respect to the second pie cut cylindrical segment, and guiding the multi joint tool through a u-joint of the gas turbine engine.

Certain embodiments may include pie cut cylinders or pie cut cylindrical segments that may be coupled or sealed together to form a multi joint tool of adjustable length and adjustable geometry. The multi joint tools described herein may carry a medium, such as a fluid, internally. In some embodiments, the inner space formed by multi joint tools described herein may be used to house a working tool, a device, wiring, or another component. Any number of different tool heads could be incorporated into the modular multi joint tools described herein including, but not limited to, cameras, stereo cameras, drills, infrared cameras, laser lights, fluids based injection or spray, grasping hands, etc. Any number of segments could be added or removed to adjust a length of the described multi joint tools. The multi joint tools may have a consistent volume inner bore space that can be used to carry, guide, or transport of any sort of material or device.

It should be apparent that the foregoing relates only to certain embodiments of this application and resultant patent. Numerous changes and modifications may be made herein by one of ordinary skill in the art without departing from the general spirit and scope of this disclosure as defined by the following claims and the equivalents thereof.

We claim:

1. A multi joint tool for use with a gas turbine engine, comprising:
a plurality of pie cut cylinders connected in series;
the plurality of pie cut cylinders comprising a connecting member and a receiving portion, wherein the plurality of pie cut cylinders is connected by a first connecting member of a first pie cut cylinder engaged with a first receiving portion of a second pie cut cylinder; and
an end cut cylinder forming a first end of the multi-joint tool, the end cut cylinder comprising a second connecting member engaged with a second receiving portion of the first pie cut cylinder.

2. The multi-joint tool of claim 1, wherein the plurality of pie cut cylinders comprises a first angled end and a second angled end.

3. The multi joint tool of claim 2, wherein the first angled end is angled towards the second angled end, and the second angled end is angled towards the first angled end.

4. The multi-joint tool of claim 1, wherein the plurality of pie cut cylinders comprises a tapered portion between a first side of the plurality of pie cut cylinders and a second side of the plurality of pie cut cylinders.

5. The multi-joint tool of claim 4, wherein the first side has a first height and the second side has a second height that is less than the first height.

6. The multi joint tool of claim 1, wherein the end cut cylinder comprises a flat end and an angled end.

7. The multi-joint tool of claim 1, wherein the plurality of pie cut cylinders has one degree of freedom between respective pie cut cylinders.

8. The multi joint tool of claim 1, further comprising a controller configured to control movement of the plurality of pie cut cylinders.

9. The multi-joint tool of claim 1, wherein the plurality of pie cut cylinders are configured to be rotated in a first configuration to form a first curve with a first radius, and in a second configuration to form a second curve with a second radius that is greater than the first radius.

10. The multi-joint tool of claim 1, wherein each pie cut cylinder of the plurality of pie cut cylinders is configured to rotate with respect to an adjacent pie cut cylinder.

11. The multi-joint tool of claim 1, wherein the plurality of pie cut cylinders forms a central passage having a consistent diameter.

12. The multi joint tool of claim 1, further comprising one or more of a tool head, a camera, a robot, a light, or a spray device at a second end of the multi-joint tool.

13. The multi-joint tool of claim 1, wherein the multi-joint tool comprises one or more bends and has an adjustable length.

14. The multi-joint tool of claim 1, wherein the plurality of pie cut cylinders is symmetrical about a longitudinal axis.

15. A method of using a multi-joint tool with a gas turbine engine, comprising:
providing a first pie cut cylindrical segment;
attaching a second pie cut cylindrical segment to the first pie cut cylindrical segment;
attaching an end cut cylindrical segment to the second pie cut cylindrical segment;
rotating the first pie cut cylindrical segment with respect to the second pie cut cylindrical segment; and
guiding the multi-joint tool through a u-joint of the gas turbine engine.

16. A serially connected multi joint tool for use with a gas turbine engine comprising a u-joint, comprising:
a first pie cut cylindrical segment with a first angled surface and a second angled surface opposite the first angled surface;
a second pie cut cylindrical segment mechanically attached to the first pie cut cylindrical segment, the second pie cut cylindrical segment comprising a third angled surface adjacent to the second angled surface of the first pie cut cylindrical segment, wherein the first pie cut cylindrical segment is configured to rotate with respect to the second pie cut cylindrical segment; and
an end cut cylindrical segment mechanically attached to the second pie cut cylindrical segment, the end cut cylindrical segment comprising a fourth angled surface adjacent to the second pie cut cylindrical segment, and a flat surface opposite the fourth angled surface.

17. The multi-joint tool of claim 16, wherein the first pie cylindrical segment comprises a first side with a first thickness and a second side with a second thickness that is less than the first thickness.

18. The multi-joint tool of claim 16, wherein the first angled surface and the second angled surface are angled towards each other.

19. The multi-joint tool of claim 16, wherein the multi-joint tool is configured to bend into a u-shape.

20. The multi joint tool of claim 16, wherein the multi joint tool comprises an inner space having a consistent diameter.
